(19) United States
(12) Patent Application Publication
(10) Pub. No.: US 2026/0111269 A1
(43) Pub. Date: Apr. 23, 2026

(54) DISTRIBUTED MESH NETWORK OF HIGH PERFORMANCE AUTOMOTIVE ELECTRONIC CONTROL UNITS

(71) Applicant: FCA US LLC, Auburn Hills, MI (US)

(72) Inventors: Daniel Cashen, Auburn Hills, MI (US); Emily A. Robb, Auburn Hills, MI (US); Rajeev Tiwari, Auburn Hills, MI (US); Esaias Pech, Auburn Hills, MI (US)

(21) Appl. No.: 18/918,286

(22) Filed: Oct. 17, 2024

(51) Int. Cl. G06F 9/50

(52) U.S. Cl. CPC G06F 9/5027

(57) ABSTRACT

A distributed mesh network for a vehicle includes a first high performance computing (HPC) electronic control unit (ECU) configured to execute a load prioritization and balancing technique and a second HPC ECU configured to execute the load prioritization and balancing technique, wherein, in response to a processing task, the first and second HPC ECUs each obtain a set of inputs indicative of parameters of the distributed mesh network, the first and second HPC ECUs each execute the load prioritization and balancing technique based on the set of inputs to obtain a desired processing allocation of the processing task between the first and second HPC ECUs, and the first and second HPC ECUs execute the processing task according to the desired processing allocation to obtain and output a final result for the processing task.

### FIELD

The present application generally relates to automotive networks and, more particularly, to a distributed mesh network of high performance automotive electronic control units (ECUs).

### BACKGROUND

Today's automobiles include a plurality of electronic control units (ECUs) including multiple edge or standalone ECUs (with limited connectivity) that are centrally connected via various communication buses (controller area network (CAN) bus, Ethernet, etc.). Typically, one high performance computing (HPC) capable ECU is configured as a supervisory ECU that acts as a centralized node for the various network processing tasks. The cost/benefit between edge/standalone ECUs versus a centralized supervisory HPC ECU reaches a density inflection point where the central supervisory HPC ECU becomes overloaded with processing tasks while other ECUs have processing availability. One example of this overloading is the processing or rendering of high bandwidth video stream data. The central supervisory HPC ECU could be further upgraded to handle this load, but this increases costs. Accordingly, while such conventional automotive networks do work well for their intended purpose, there exists an opportunity for improvement in the relevant art.

### SUMMARY

According to one aspect of the invention, a distributed mesh network for a vehicle is presented. In one exemplary implementation, the distributed mesh network comprises a first high performance computing (HPC) electronic control unit (ECU) configured to execute a load prioritization and balancing technique and a second HPC ECU configured to execute the load prioritization and balancing technique, wherein, in response to a processing task, the first and second HPC ECUs each obtain a set of inputs indicative of parameters of the distributed mesh network, the first and second HPC ECUs each execute the load prioritization and balancing technique based on the set of inputs to obtain a desired processing allocation of the processing task between the first and second HPC ECUs, and the first and second HPC ECUs execute the processing task according to the desired processing allocation to obtain and output a final result for the processing task.

In some implementations, the set of inputs indicate (i) computing capabilities of the first and second HPC ECUs, (ii) configurations of the first and second HPC ECUs, (iii) processor types of the first and second HPC ECUs, and connectivity between the first and second HPC ECUs. In some implementations, the computing capabilities include at least one of as Dhrystone million instructions per second (DMIPS), gigaflops (GFLOPs), and tera operations per second (TOPs) and wherein the configurations include at least one of an operating system (OS) and an automotive safety integrity level (ASIL). In some implementations, each of the first and second HPC ECUs includes a central processing unit (CPU), a graphical processing unit (GPU), and a neural processing unit (NPU), and wherein the processor type indicates a type of each of the CPU, the GPU, and the NPU. In some implementations, at least one of the CPU, the GPU, and the NPU of each of the first and second HPC ECUs includes multiple cores.

In some implementations, the connectivity between the first and second HPC ECUs is a communication bus connecting the first and second HPC ECUs. In some implementations, the communication bus is automotive Ethernet and wherein the processing task is a video stream data task. In some implementations, the video stream data task is one or displaying and rendering video stream data. In some implementations, the first and second HPC ECUs are both configured to independently execute the same load prioritization and balancing technique. In some implementations, the load prioritization and balancing technique is configured to determine both (i) an order of operations for the processing task and (ii) an allocation of the operations for the processing task between the first and second HPC ECUs.

According to another aspect of the invention, a method of operating a distributed mesh network for a vehicle is presented. In one exemplary implementation, the method comprises providing a HPC ECU configured to execute a load prioritization and balancing technique, providing a second HPC ECU configured to execute the load prioritization and balancing technique, and receiving a processing task and, in response to receiving the processing task, obtaining, by each of the first and second HPC ECUs, a set of inputs indicative of parameters of the distributed mesh network, executing, by each of the first and second HPC ECUs, the load prioritization and balancing technique based on the set of inputs to obtain a desired processing allocation of the processing task between the first and second HPC ECUs, and executing, by the first and second HPC ECUs, the processing task according to the desired processing allocation to obtain and output a final result for the processing task.

In some implementations, the set of inputs indicate (i) computing capabilities of the first and second HPC ECUs, (ii) configurations of the first and second HPC ECUs, (iii) processor types of the first and second HPC ECUs, and connectivity between the first and second HPC ECUs. In some implementations, the computing capabilities include at least one of as DMIPS, GFLOPs, and TOPs and wherein the configurations include at least one of an OS and an ASIL. In some implementations, each of the first and second HPC ECUs includes a CPU, a GPU, and an NPU, and wherein the processor type indicates a type of each of the CPU, the GPU, and the NPU. In some implementations, at least one of the CPU, the GPU, and the NPU of each of the first and second HPC ECUs includes multiple cores.

In some implementations, the connectivity between the first and second HPC ECUs is a communication bus connecting the first and second HPC ECUs. In some implementations, the communication bus is automotive Ethernet and wherein the processing task is a video stream data task. In some implementations, the video stream data task is one or displaying and rendering video stream data. In some implementations, the first and second HPC ECUs are both configured to independently execute the same load prioritization and balancing technique. In some implementations, the load prioritization and balancing technique is configured to determine both (i) an order of operations for the processing task and (ii) an allocation of the operations for the processing task between the first and second HPC ECUs.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a vehicle having an example decentralized mesh network according to the principles of the present application;

FIG. 2 is a functional block diagram of an example architecture for the decentralized mesh network according to the principles of the present application; and

FIG. 3 is a flow diagram of an example decentralized mesh networking method for a vehicle according to the principles of the present application.

### DESCRIPTION

As previously discussed, today's automobiles include a plurality of electronic control units (ECUs) including multiple edge or standalone ECUs (with limited connectivity) that are centrally connected via various communication buses (controller area network (CAN) bus, Ethernet, etc.). Typically, one high performance computing (HPC) capable ECU is configured as a supervisory ECU that acts as a centralized node for the various network processing tasks. The cost/benefit between edge/standalone ECUs versus a centralized supervisory HPC ECU reaches a density inflection point where the central supervisory HPC ECU becomes overloaded with processing tasks while other ECUs have processing availability. One example of this overloading is the processing or rendering of high bandwidth video stream data. The central supervisory HPC ECU could be further upgraded to handle this load, but this substantially increases costs. Therefore, while these conventional techniques do work for their intended purpose, an opportunity for improvement exists in the relevant art.

Accordingly, an improved distributed or decentralized mesh network where multiple edge (non-central) HPC ECUs perform load prioritization and balancing amongst each other to distribute various processing tasks. For purposes of this application, the term HPC ECU refers to an ECU that includes a central processing unit (CPU), a graphical processing unit (GPU), and a neural processing unit (NPU), each of which could further include multiple cores. The load prioritization and balancing algorithm runs on each HPC ECU to redundantly determine the next operational state and loading conditions, and thus each HPC ECU is independently aware of the operational state of the entire system. Inputs to the algorithm include, for example only, compute capabilities, configurations, type, system design state, and connectivity. For each new processing request, the algorithm determines the most appropriate HPC ECU to execute the processing request (or portions thereof). Potential benefits include increased performance (features, redundancy, etc.) and/or decreased costs.

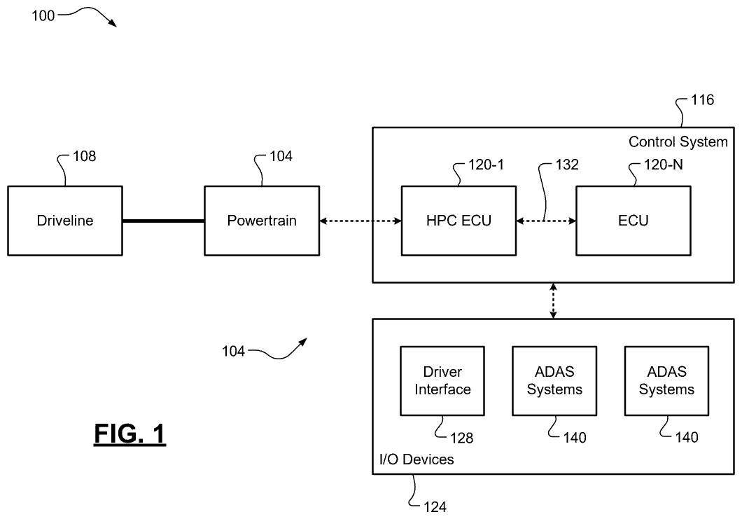

Referring now to FIG. 1, a functional block diagram of a vehicle 100 (e.g., a passenger automobile) having an example decentralized mesh network 104 according to the principles of the present application is illustrated. The vehicle 100 comprises a powertrain 108 configured to generate and transfer torque to a driveline 112 for propulsion. Non-limiting examples of the components of the powertrain 108 include one or more torque generating systems (an internal combustion engine, an electric traction motor, etc.) and an optional transmission or optional gear reducer. A control system 116 comprising one or more ECUs 120-1 . . . 120-N (collectively, “ECUs 120”) is configured to control operation of the vehicle 100, including controlling the powertrain 108 to generate and transfer a desired amount of torque to the driveline 112 to satisfy a driver torque request received from a driver interface 128 (e.g., an accelerator pedal), which is one of a plurality of input/output (I/O) devices 124 of the vehicle 100. The driver interface 128 could also include other suitable input/output components, such as a display. The ECUs 120 are connected to each other via one or more buses 132, including, but not limited to, CAN buses and automotive Ethernet buses.

At least two of the ECUs 120 are HPC capable ECUs (hereinafter, “HPC ECU 120a” and “HPC ECU 120b”). In one exemplary implementation, the term HPC as used herein indicates that the particular ECU includes a CPU, a GPU, and an NPU, each of which could further include one or more cores. However, it will be appreciated that an HPC ECU could merely be a particular ECU that has greater processing capabilities compared to other edge/standalone ECUs 120 of the control system 116. The vehicle 100 can further include a set of one or more advanced driver-assistance (ADAS) or autonomous driving systems 136 (of the I/O devices 124), which can include or utilize one or more camera systems 140 (of the I/O devices 124) that are each configured to capture images or video streams relative to the vehicle 100. Video stream data could be communicated, for example, via the higher speed automotive Ethernet buses 132 compared to the slower or lower speed CAN buses. The control system 116 and, more particularly, the HPC ECUs 120a, 120b are configured to execute the load prioritization and balancing techniques of the present application.

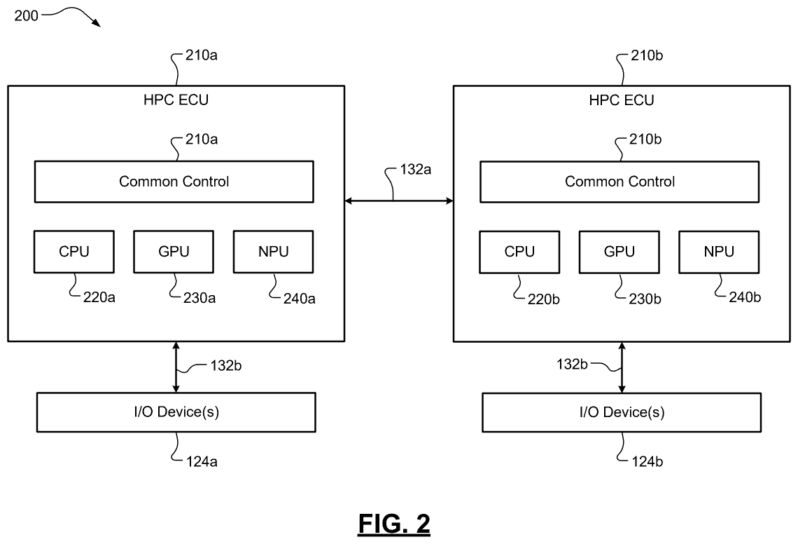

Referring now to FIG. 2 and with continued reference to FIG. 1, a functional block diagram of an example system architecture 200 for the distributed mesh network 104 is illustrated. As shown, the first HPC ECU 120a is connected to the second HPC ECU 120b via a high speed connection, such as an automotive Ethernet or peripheral component interconnect (PCI) bus 132. The first HPC ECU 120a includes a common control block or algorithm 210a as well as a CPU 220a, a GPU 230a, and an NPU 240a, and is also configured to communicate with a first set of peripheral or I/O devices 124a. Similarly, the second HPC ECU 120b includes another common control block or algorithm 210b (which could be the same as 210a) as well as a CPU 220b, a GPU 230b, and an NPU 240b, and is also configured to communicate with a second set of peripheral or I/O devices 124b. The common control blocks or algorithms 210a, 210b (alternatively, “common control 210” or “algorithm 210”) are each configured to execute a prediction algorithm that determines the operational direction for the automotive system as opposed to induvial modules or a central HPC ECU managing their own operational state.

This algorithm 210 runs on each HPC ECU 120a, 120b to redundantly determine the next operational state and loading conditions. Each HPC ECU 120a, 120b is thereby independently aware of the operational state of the entire system 116. Inputs to the algorithm 210 include (i) computing capabilities, such as Dhrystone million instructions per second (DMIPS), which is an indicator of processing speed, gigaflops (GFLOPs), tera operations per second (TOPs), etc., (ii) configurations, such as operating system (OS), automotive safety integrity level (ASIL), etc., (iii) processor type, such as A, R, M, etc., (iv) system design state, and (v) connectivity, such as time to transfer (1 gigabit/second, 10 gigabit/second, etc.). For multi-core processors, for example, one or multiple cores may be unused by a particular HPC ECU. For example only, a particular HPC ECU may include an NPU that is not fully utilized because it does not execute any neural network models or only utilizes less than a total number of cores of its NPU. The same applies to, for example, GPUs and CPUs that are not fully utilized.

When a new process execution request or sate change for a current request is submitted to the system 116 or any HPC ECU 120 in the system 116, the algorithm 210 determines the most appropriate HPC ECU 120 to execute the request based on the above-described inputs such as available compute resources, connection speeds, I/O, and expected load. The specific processing cost function for this load prioritization and balancing algorithm 210 could vary depending on the particular design of the vehicle 100 and, more specifically, its control system 116. It may be common for the requesting HPC ECU 120 to fulfill its own request and provide the needed capability but it is also possible for any HPC ECU 120 enabled with the right permissions and priority leverage the compute of another HPC ECU 120. This concept is further extended to create virtual ECUs that do not have a specific hardware assignment for low priority functions such as data collection. Computation can also be set to be redundant for critical functions.

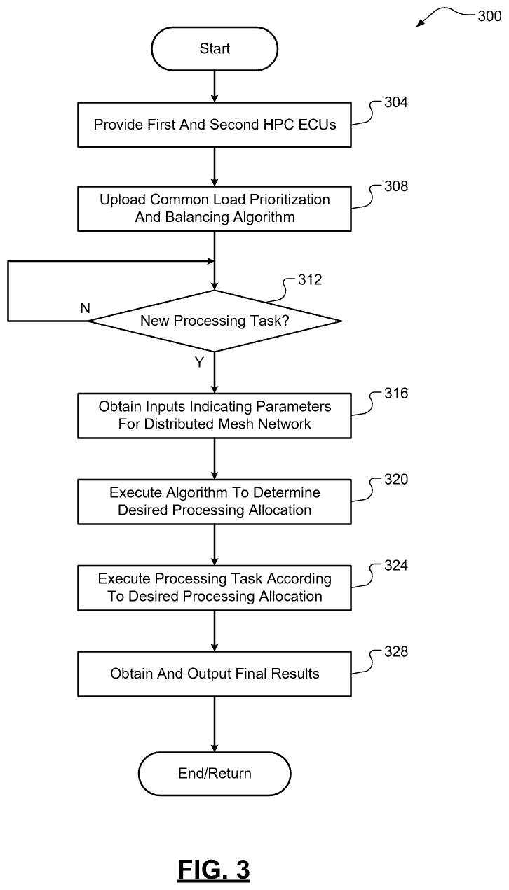

Referring now to FIG. 3, a flow diagram of an example method 300 of operating a distributed mesh network of a vehicle according to the principles of the present application is illustrated. While the method 300 specifically references the vehicle 100 and its components, it will be appreciated that the method 300 could be applicable to any suitably configured vehicle 100 (e.g., having multiple HPC ECUs). The method 300 begins at 304 where the distributed mesh network 104 including at least two interconnected HPC ECUs 120 is established. At 308, each HPC ECU 120 is loaded with a common load prioritization and balancing algorithm (e.g., algorithm 210). At 312, it is determined whether a new request for a processing task has been received by the control system 116 or one of the HPC ECUs 120. When false, the method 300 ends or returns to 308. When true, the method 300 proceeds to 316. At 316, each HPC ECU 120 obtains the inputs indicative of the parameters of the distributed mash network 104. At 320, each HPC ECU 120 executes its common load prioritization and balancing algorithm to determine a desired processing distribution of the processing task amongst the HPC ECUs 120.

This desired processing distribution could include a desired allocation of operations of the processing task between the HPC ECUs 120 and, in some implementations, a priority or order for the operations to be processed at each HPC ECU 120. In one exemplary implementation, the processing task is a processing task for video stream data. This could include, for example, displaying or rendering the video stream data. This type of data is very large and computationally expensive and thus could likely overload a particular HPC ECU 120. For example, the GPU 230 of a particular HPC ECU 210 could be overloaded due to the processing task, and thus a portion of the GPU 230 of another HPC ECU 210 could be utilized to perform a portion of the processing task. In another exemplary implementation, the processing task could be a neural network modeling task. This type of data is desirable for processing by the NPUs 240, and one of the HPC ECUs 210 may not be using its NPU 240 at all or at some times. At 324, the HPC ECUs 120 execute the processing task according to the desired processing distribution. At 328, the HPC ECUs 120 output a final result or output of for the processing task. The method 300 then ends or returns to 304 or 312 for one or more additional cycles.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A distributed mesh network for a vehicle, the distributed mesh network comprising:
a first high performance computing (HPC) electronic control unit (ECU) configured to execute a load prioritization and balancing technique; and
a second HPC ECU configured to execute the load prioritization and balancing technique,
wherein, in response to a processing task:
the first and second HPC ECUs each obtain a set of inputs indicative of parameters of the distributed mesh network;
the first and second HPC ECUs each execute the load prioritization and balancing technique based on the set of inputs to obtain a desired processing allocation of the processing task between the first and second HPC ECUs; and
the first and second HPC ECUs execute the processing task according to the desired processing allocation to obtain and output a final result for the processing task.

2. The distributed mesh network of claim 1, wherein the set of inputs indicate (i) computing capabilities of the first and second HPC ECUs, (ii) configurations of the first and second HPC ECUs, (iii) processor types of the first and second HPC ECUs, and connectivity between the first and second HPC ECUs.

3. The distributed mesh network of claim 2, wherein the computing capabilities include at least one of as Dhrystone million instructions per second (DMIPS), gigaflops (GFLOPs), and tera operations per second (TOPs) and wherein the configurations include at least one of an operating system (OS) and an automotive safety integrity level (ASIL).

4. The distributed mesh network of claim 2, wherein each of the first and second HPC ECUs includes a central processing unit (CPU), a graphical processing unit (GPU), and a neural processing unit (NPU), and wherein the processor type indicates a type of each of the CPU, the GPU, and the NPU.

5. The distributed mesh network of claim 4, wherein at least one of the CPU, the GPU, and the NPU of each of the first and second HPC ECUs includes multiple cores.

6. The distributed mesh network of claim 2, wherein the connectivity between the first and second HPC ECUs is a communication bus connecting the first and second HPC ECUs.

7. The distributed mesh network of claim 6, wherein the communication bus is automotive Ethernet and wherein the processing task is a video stream data task.

8. The distributed mesh network of claim 7, wherein the video stream data task is one or displaying and rendering video stream data.

9. The distributed mesh network of claim 1, wherein the first and second HPC ECUs are both configured to independently execute the same load prioritization and balancing technique.

10. The distributed mesh network of claim 9, wherein the load prioritization and balancing technique is configured to determine both (i) an order of operations for the processing task and (ii) an allocation of the operations for the processing task between the first and second HPC ECUs.

11. A method of operating a distributed mesh network for a vehicle, the method comprising:
providing a first high performance computing (HPC) electronic control unit (ECU) configured to execute a load prioritization and balancing technique;
providing a second HPC ECU configured to execute the load prioritization and balancing technique; and
receiving a processing task and, in response to receiving the processing task:
obtaining, by each of the first and second HPC ECUs, a set of inputs indicative of parameters of the distributed mesh network;
executing, by each of the first and second HPC ECUs, the load prioritization and balancing technique based on the set of inputs to obtain a desired processing allocation of the processing task between the first and second HPC ECUs; and
executing, by the first and second HPC ECUs, the processing task according to the desired processing allocation to obtain and output a final result for the processing task.

12. The method of claim 11, wherein the set of inputs indicate (i) computing capabilities of the first and second HPC ECUs, (ii) configurations of the first and second HPC ECUs, (iii) processor types of the first and second HPC ECUs, and connectivity between the first and second HPC ECUs.

13. The method of claim 12, wherein the computing capabilities include at least one of as Dhrystone million instructions per second (DMIPS), gigaflops (GFLOPs), and tera operations per second (TOPs) and wherein the configurations include at least one of an operating system (OS) and an automotive safety integrity level (ASIL).

14. The method of claim 12, wherein each of the first and second HPC ECUs includes a central processing unit (CPU), a graphical processing unit (GPU), and a neural processing unit (NPU), and wherein the processor type indicates a type of each of the CPU, the GPU, and the NPU.

15. The method of claim 14, wherein at least one of the CPU, the GPU, and the NPU of each of the first and second HPC ECUs includes multiple cores.

16. The method of claim 12, wherein the connectivity between the first and second HPC ECUs is a communication bus connecting the first and second HPC ECUs.

17. The method of claim 16, wherein the communication bus is automotive Ethernet and wherein the processing task is a video stream data task.

18. The method of claim 17, wherein the video stream data task is one or displaying and rendering video stream data.

19. The method of claim 11, wherein the first and second HPC ECUs are both configured to independently execute the same load prioritization and balancing technique.

20. The method of claim 19, wherein the load prioritization and balancing technique is configured to determine both (i) an order of operations for the processing task and (ii) an allocation of the operations for the processing task between the first and second HPC ECUs.
